(19) United States
(12) Patent Application Publication
(10) Pub. No.: US 2017/0017584 A1
(43) Pub. Date: Jan. 19, 2017

(54) SPI Interface With Less-Than-8-Bit Bytes And Variable Packet Size

(71) Applicant: Microchip Technology Incorporated, Chandler, AZ (US)

(72) Inventors: Kevin Kilzer, Chandler, AZ (US); Shyamsunder Ramanathan, Tucson, AZ (US); Sai Karthik Rajaraman, Chandler, AZ (US); Justin Milks, Tempe, AZ (US)

(73) Assignee: Microchip Technology Incorporated, Chandler, AZ (US)

(21) Appl. No.: 15/209,467

(22) Filed: Jul. 13, 2016

Related U.S. Application Data
(60) Provisional application No. 62/192,773, filed on Jul. 15, 2015.

(51) Int. Cl. G06F 13/10; G06F 13/40; G06F 13/42; G06F 13/16

(52) U.S. Cl. CPC G06F 13/102; G06F 13/1673; G06F 13/1689; G06F 13/4068; G06F 13/4282

(57) ABSTRACT

A synchronous serial peripheral device has a transmission unit coupled with a data output line and a clock unit coupled with a clock line. The serial peripheral device transmits a minimum of a single transmission, wherein in a first operating mode the transmission unit and the clock unit are configurable to perform a data transmission with a data length that can be defined to be between one (1) and eight (8) bit.

### RELATED PATENT APPLICATION

This application claims priority to commonly owned U.S. Provisional Patent Application No. 62/192,773; filed Jul. 15, 2015; which is hereby incorporated by reference herein for all purposes.

### TECHNICAL FIELD

The present disclosure relates to synchronous serial peripheral interface, in particular an SPI interface with less than 8-bit bytes and variable packet size.

### BACKGROUND

Synchronous serial peripheral devices use separate data and clock lines, wherein a minimum data size is 8-bit. The devices are common interface peripherals in microcontrollers. They may also be used in a plurality of stand-alone devices, such as analog-to-digital converters, digital-to-analog converters, sensor devices, transmitters and receivers and any other type of device that needs to communicate with a microprocessor or microcontroller.

### SUMMARY

According to an embodiment, a synchronous serial peripheral device may comprise a transmission unit coupled with a data output line and a clock unit coupled with a clock line, wherein the serial peripheral device transmits a minimum of a single transmission, wherein in a first operating mode the transmission unit and the clock unit are configurable to perform a data transmission with a data length that can be defined to be between one (1) and eight (8) bit.

According to a further embodiment, the synchronous serial peripheral device may further comprise a FIFO memory coupled with the transmission unit, wherein the peripheral device is further configurable to operate in a second operating mode in which a transmission consists of a transmission frame comprising a plurality of 8-bit words from the FIFO memory followed by a single data transmission word from the FIFO memory having a data length that can be defined to be less than eight (8) bit. According to a further embodiment, a single bit in a configuration register determines whether the first or second operating mode is active. According to a further embodiment, the synchronous serial peripheral device may further comprise a reception unit coupled with a data input line, wherein the serial peripheral device is configured to receive a variable bit length single serial transmission, wherein in the first operating mode the reception unit is configurable to receive a data transmission with the defined data length. According to a further embodiment, in the first operating mode a plurality bits in a configuration register determine the data length. According to a further embodiment, in the second operating mode a first number of special function register bits determine a number of consecutive 8-bit words and a second number of special function register bits determine the number of bits of the single data transmission word after the consecutive 8-bit words have been transmitted. According to a further embodiment, in the first operating mode a first number of special function register bits determine the data length and in the second operating mode a second number of special function register bits determine a number of consecutive 8-bit words and the first number of special function register bits determine the number of bits of the single data transmission word. According to a further embodiment, a single special function register comprises the first and second number of special function register bits. According to a further embodiment, the synchronous serial peripheral device may further comprise a finite state machine controlling a clock signal transmitted on the clock line. According to a further embodiment, the synchronous serial peripheral device may further comprise a byte counter and a bit counter controlling the finite state machine. According to a further embodiment, the bit counter controls the transmission unit. According to a further embodiment, a PWM/Manchester encoding for each bit of data is emulated by adjusting the baud rate, the number of bits, and the data to achieve the required modulated pattern. According to a further embodiment, the synchronous serial peripheral device may further comprise a slave control input. According to a further embodiment, the synchronous serial peripheral device may further comprise separate data input and data output lines.

According to another embodiment, a microcontroller may comprise a synchronous serial peripheral device as described above.

According to yet another embodiment, a method of operating a synchronous serial peripheral device may comprise the steps of: configuring the synchronous serial peripheral device to operate in a first transmission mode; setting a transmission bit width to length less than 8 bits; moving data into a transfer buffer; wherein in master mode upon receiving said data the synchronous serial peripheral device transmits data on a data line and an associated clock signal on a clock line, wherein a number of bits less than 8 bits is transmitted on the data line and a number of less than 8 clock pulses is transmitted on the clock line.

According to a further embodiment of the method, in slave mode, the synchronous peripheral device transmits data on a data line upon receiving clock signal from the master on a clock line. According to a further embodiment of the method, the method may further comprise the steps of: configuring the synchronous serial peripheral device to operate in a second transmission mode; setting a number of 8-bit words and a bit width to length less than 8 bits; moving data into a transmission FIFO memory; wherein upon receiving a trigger, the synchronous serial peripheral device transmits a plurality of 8-bit words from the transmission FIFO memory followed by a single data transmission word having a data length that can be defined to be less than eight (8) bit. According to a further embodiment of the method, a single bit in a configuration register determines whether the first or second operating mode is active. According to a further embodiment of the method, setting a bit in a control register generates the trigger. According to a further embodiment of the method, the method may further comprise: when in the first operating mode, receiving a data word having said transmission bit width, and when in the second operating mode, receiving said number of 8-bit words and a final word having a length of less than eight bits, wherein each received word is transferred into a reception FIFO memory. According to a further embodiment of the method, in the first operating mode a plurality bits in a configuration register determine the data length. According to a further embodiment of the method, in the first operating mode a first number of special function register bits determine the data length and in the second operating mode a second number of special function register bits determine a number of consecutive 8-bit words and the first number of special function register bits determine the number of bits of the single data transmission word. According to a further embodiment of the method, a PWM/Manchester encoding for each bit of data is emulated by adjusting the baud rate, the number of bits, and the data to achieve the required modulated pattern.

### BRIEF DESCRIPTION OF THE DRAWINGS

FIG. 1 shows a block diagram of an embodiment of a synchronous serial peripheral module;

FIG. 2 shows a system with a master and a plurality of slave units coupled through an SPI interface;

FIG. 3 shows a timing diagram of a conventional SPI transmission;

FIG. 4 shows a timing diagram of an SPI transmission with less than eight bits according to a first operating mode;

FIG. 5 shows a timing diagram of an SPI transmission according to a second operating mode;

FIG. 6 shows a typical transmission protocol used for a in-circuit debugger/programmer;

FIG. 7 shows a transmission according to a first operating mode that emulates a PWM/Manchester encoding;

FIG. 8 shows a first configuration of a conventional SPI module;

FIG. 9 shows a second configuration of a conventional SPI module; and

FIG. 10, shows a block diagram of a microcontroller comprising an SPI module according to various embodiments.

### DETAILED DESCRIPTION

Applications employing RF transmission of serial data are improved if the transmitter sends only the bits necessary. When devices can generate serial data using only 8-bit bytes, then sometimes excess bits must be transmitted (e.g., 32 or 40 bits), instead of the optimal number (e.g., 37 bits). The extra bits add to the total energy consumed, and take away from battery life.

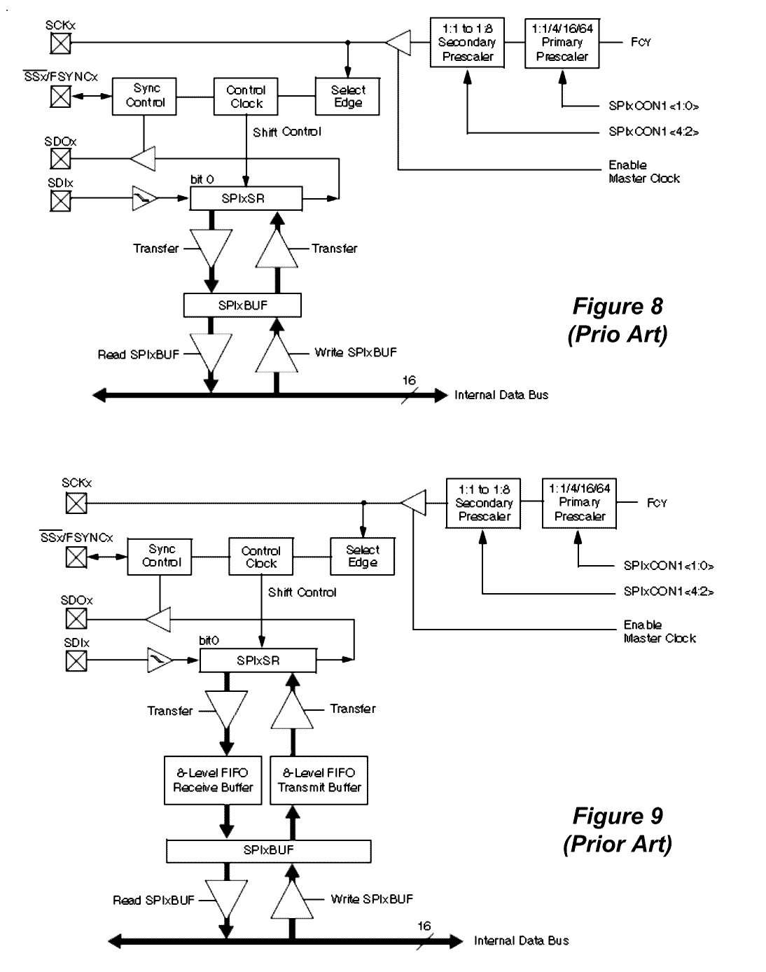

FIGS. 8 and 9 show a typical SPI peripheral module that can be implemented in a microcontroller. Such a peripheral may operate in different modes wherein a normal mode as shown in FIG. 8 uses a single buffer register SPIxBUF coupled with a shift register SPIxSR which again is coupled with external pins SDO and SDI. The shift register operates as a serializer and a de-serializer as shown in FIGS. 8 and 9. The clock signal is generated through prescalers and control logic is provided that handles the transfer protocols of signals on the SDO, SDI and SCK pins. According to the standard a fourth pin may be used for slave mode or frame synchronization. FIG. 9 shows the same module when operating in an enhanced mode. Now a FIFO receive and transmit buffer is coupled between the buffer register SPIxBUF and the shift register SPIxSR. Thus, a user can perform multiple writes which depends on the FIFO size with no timing constraints (wait states). Such a peripheral is typically configured by special function registers which are memory-mapped for easy access within a microcontroller. However, these type of SPI interfaces are limited to 8-bit or 16-bit transmissions. Currently, the only way to provide a variable bit length serial transmission is to use the so-called bit-banging technology which requires the central processor to directly control an I/O port and the timing of the signals which obviously results in a significant software overhead.

There is a need for an improved more flexible SPI interface that to a great extent handles a serial transmission with variable data width automatically.

According to various embodiments, an SPI module as shown in FIGS. 8 and 9 can be further enhanced. For example, the SPI data serializer and deserializer can be modified so that not all bytes that are transmitted need be 8 bits long. To this end, a special function register that controls the operation of the SPI peripheral is controlled amongst others, for example, by a single mode bit or multiple bits that control a specific setting. Using a single bit BMODE allows for two modes. When BMODE=0, a total bit count is specified, for example, a transmission having a length of 37 bits. The actual length may be set in a special function register. In this mode, after transmitting a plurality of 8-bit bytes, a final byte, for example in one setting the 5th byte, is truncated to the necessary length. Thus, four normal 8-bit words and one 5-bit word would be sequentially transmitted to result in a 37 bit transmission.

When BMODE=1, each byte is truncated to a selected bit-count. This mode allows to define every transmission to be made with, for example, less than 8 bits. However, the setting could be between 1-8 bits with the 8-bit setting being equivalent to a normal transmission.

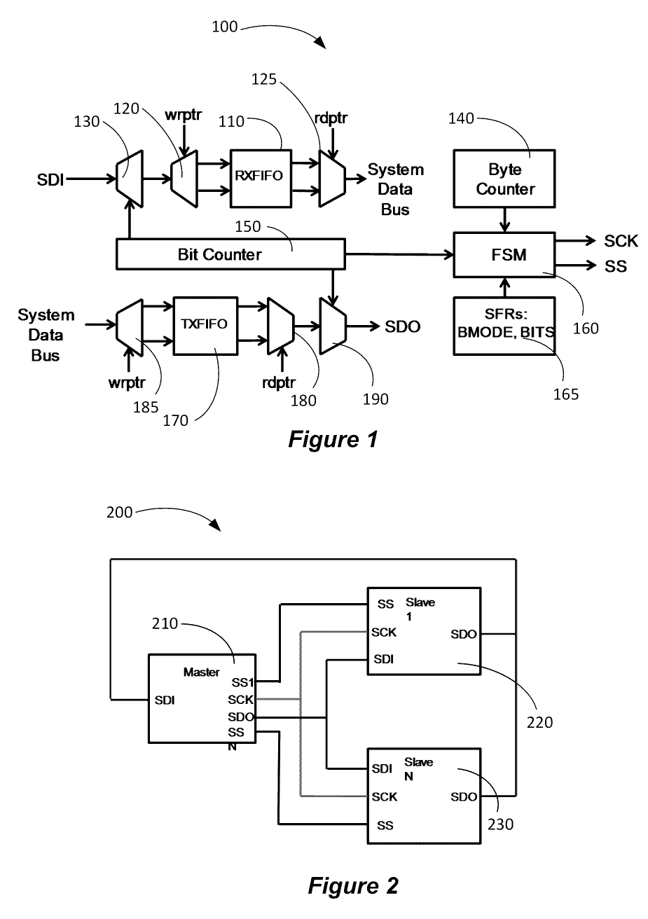

According to one embodiment, only a single operating mode is provided wherein this mode is equivalent to the BMODE=1. This embodiment does not require a FIFO memory as discussed below with a two operating mode embodiment but may be implemented similar to the SPI peripheral shown in FIG. 8. Thus, instead of a FIFO, a single transmit buffer register and a single transmit receive register, similar to the arrangement shown in FIG. 8, may be provided instead of the FIFO multiplexer arrangement as shown in FIG. 1.

Thus, a SPI module according to various embodiments allows data transfers of variable size. As mentioned above, according to one embodiment, there can be two modes implemented to achieve variable transfer size:
Mode 1—Variable packet size mode. The packet size can, for example, be between 9 to 16391 bits. Other packet sizes may apply depending on the implementation.
Mode 2—Variable byte size mode. The size of each byte can be between 1 to 8 bits.

Efficient implementation for variable byte size is achieved using a bit selector to directly multiplex transmit FIFO data onto an SDO output and to receive SDI input signals via a de-serializer and an associated receive FIFO. In addition, a master mode finite state machine uses the byte_count and bit_count information to generate variable number of SCK pulses. FIG. 1 shows a block diagram of a synchronous serial peripheral device 100 according to an embodiment.

A first de-serializer 130 receives a serial SDI signal and forwards a parallel 8-bit signal to a first multiplexer 120 which is coupled with a N-deep receive FIFO 110. De-serializer 130 is controlled by bit counter 150 which also controls finite state machine 160 which outputs clock signal SCK. Finite State machine 160 is further coupled with byte counter 140. An N-deep transmit FIFO 170 is coupled with multiplexer 180 which outputs an 8-bit parallel signal to serializer 190 whose output provides the SDO signal.

The ability to both truncate bytes and complete a data load/store operation is performed with 8 bits per byte, but requires special consideration in the data controls. In particular, transferring only 1-bit per byte is very difficult while maintaining continuous data clocking (a requirement for the RF transmission). The bit counter interacts with the finite state machine, and the transmitter and receiver, to make sure that all are in the same state.

Operation of such a synchronous serial peripheral device in “Master mode” may be as follows. First, the synchronous serial peripheral device is configured to operate in one of the two operating modes unless only a single mode is available as discussed above. In a first transmission mode, a transmission bit width to a length of up to 8 bits is set. If a FIFO or a transfer buffer is used to receive the data, each such transfer may trigger a transmission. In case of a FIFO, the peripheral will simply transfer as long as there is valid data in the FIFO. Thus, upon receiving the data the synchronous serial peripheral device transmits data on a data line and an associated clock signal on a clock line, wherein a number of bits which can be less than 8 bits is transmitted on the data line and an associated number of clock pulses is transmitted on the clock line.

Operation of such a synchronous serial peripheral device in “Slave mode” may be as follows. First, the synchronous serial peripheral device is configured to operate in one of the two operating modes unless only a single mode is available as discussed above. In a first transmission mode, a transmission bit width to a length of up to 8 bits is set. The peripheral will simply transfer once it receives the clocks from the master provided there is data in the FIFO. Thus, upon receiving the clock from the master the synchronous serial peripheral device transmits data on a data line, wherein a number of bits which can be less than 8 bits is transmitted on the data line.

In the second transmission mode, a number of 8-bit words and a bit width to length less than 8 bits is first programmed into the respective special function register or registers. Then, data is moved into the transmission FIFO memory which may require a plurality of data transfers depending on the overall bit length of the transmission. Thus, in this operating mode, the synchronous serial peripheral device transmits a plurality of 8-bit words from the transmission FIFO memory followed by a single data transmission word having a data length that can be defined to be less than eight (8) bit. The transfer may automatically begin, according to one embodiment, once enough data has been received in the FIFO. According to another embodiment, a single bit in a configuration register which can be set by a user determines the start of transfer.

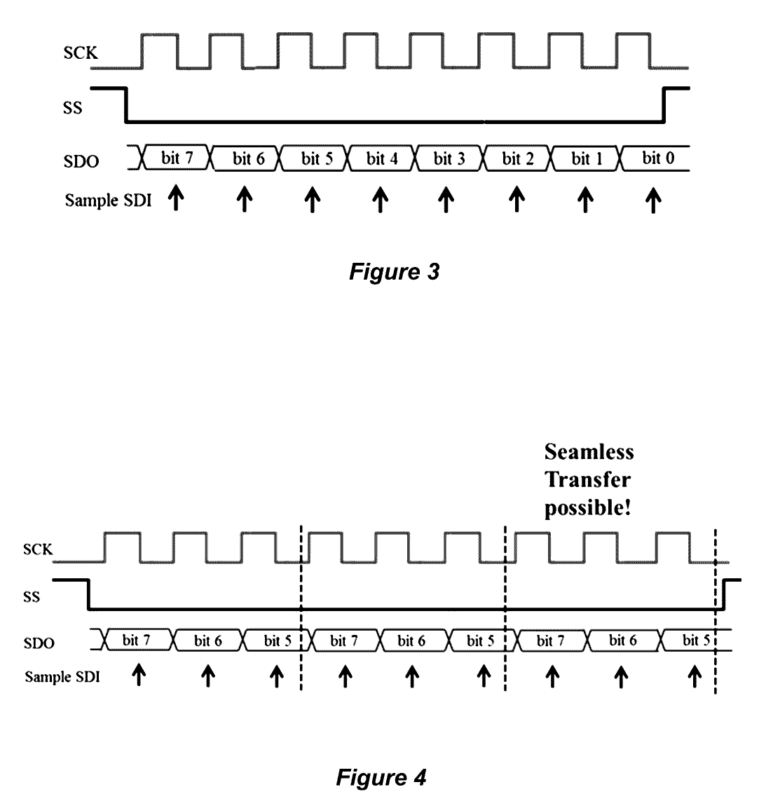

SPI transfers data serially between multiple devices. FIG. 2 shows a typical arrangement 200 with a master 210 and a plurality of slaves 220, 230. The serial output data is changed on a particular SCK edge and the data is sampled on the next SCK edge as shown in the timing diagram of FIG. 3. Conventional SPI systems transfer data word-wise, where the word size=data bus width (8 bit MCU=>8 bit SPI bytes). Some systems also offer a data transfer width of 16 bit.

According to an embodiment, a packet-size option can be implemented which provides a feature that is not currently available in conventional SPI interfaces.

As shown in FIG. 4, The SPI peripheral has a byte transfer mode according to a specific programmable operating mode, wherein each transfer involves sending/receiving one byte. The size of each byte can be between 1 to 8 bits. A respective special function register (SFR) controls this function: This register can be programmed for example by a single bit BMODE, wherein a setting of BMODE=1 is used for a byte mode, and a plurality of bits (BITS) in this or another special function register define the number of bits for the byte size. Example as shown in FIG. 4: the control register has a setting of BMODE=1, BITS=3. In this mode only 3 bits, namely the most significant bits 7, 6, and 5, are transferred with each writing to the buffer transfer register.

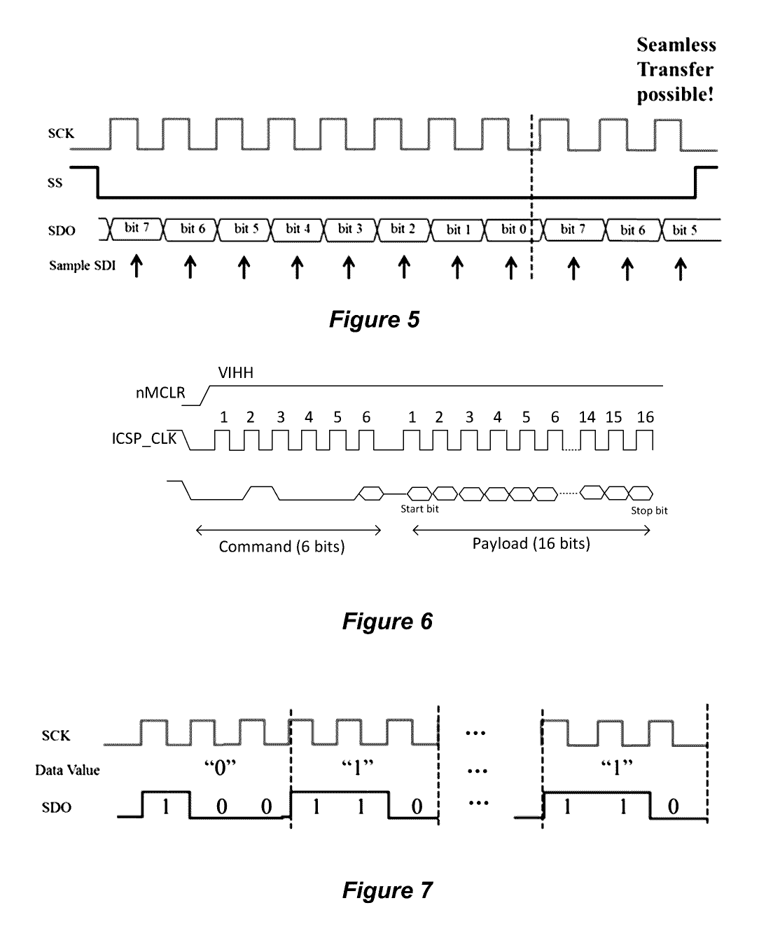

As shown in FIG. 5, The SPI peripheral may also have a packet transfer mode according to specific programmable operating mode. The packet size can be between 9 to 16391 bits. However, as stated above, other sizes may apply depending on the implementation. A number of special function registers (SFR) may be used to control the setting. For example, bit BMODE=0 is used to set the packet mode, bits BYTES are used to set the number of 8-bit bytes, and bits BITS are used to set the size of the last byte. This results in a packet size (in number of bits)=BYTES*8 +BITS. The example as shown in FIG. 5 uses the setting BMODE=0, BYTES=1, and BITS=3 which results in an 11-bit operating mode.

As shown in FIG. 6, for example, a Microchip In Circuit Serial Programming (ICSP) requires a 6-bit command to be sent followed by a 16-bit payload. The first byte can be sent using BMODE=1, BITS=6 and the next two bytes can be sent using BMODE=1, BITS=0. Alternatively, this can be achieved using the packet mode with BMODE=0, BYTES=2, BITS=6 (packet size=22 bits). This enables certain microcontrollers to be used for Microchip PIC programming, which requires variable bit-length words to be transferred.

Wireless applications that require odd number of bits to be transferred can benefit from the new packet mode. For example, Keeloq® applications can have a data size between 66-192 bits.

As mentioned above, previously these applications would have to use bit banging for sending packets of exact length in order to save power by turning off the transceiver without any zero-padding overhead. The new packet mode can help in achieving higher timing accuracies than achieved by bit banging approaches. Also the seamless data transfer support can improve the bus utilization and further optimize power consumption.

As shown in FIG. 7, the new SPI module according to an embodiment can be easily used for applications requiring a PWM/Manchester encoding for each bit of data. For example, certain LED devices use the following PWM encoding to represent one bit of data. The baud rate, the number of bits, and the data can be adjusted to achieve the required modulated pattern.

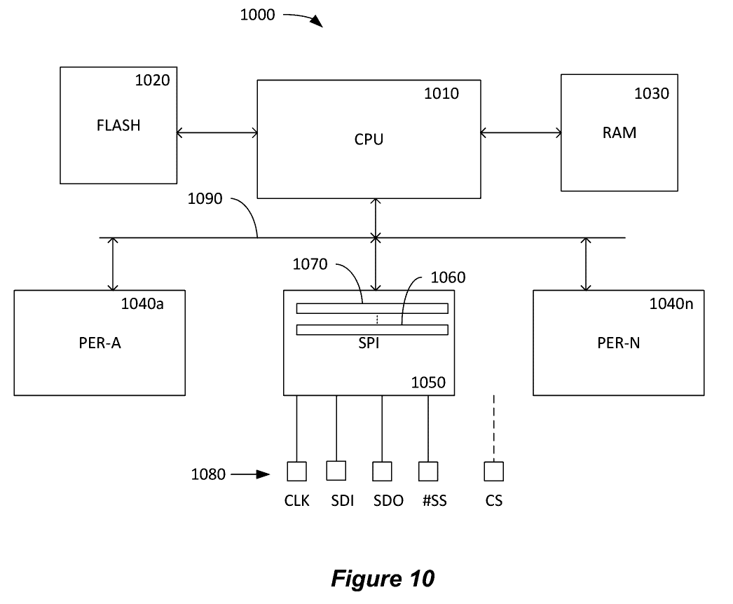

FIG. 10 shows an example of an integration of a SPI module according to various embodiments in a single chip microcontroller 1000. The microcontroller 1000 comprises a central processing unit 1010 coupled with a program flash memory 1020 and a data random access memory 1030 implementing a Harvard architecture. However, other architectures may be used according to other embodiments. An internal system bus 1090 couples the CPU 1010 with a plurality of peripheral devices 1040a . . . n. One of the peripheral devices 1050 is an SPI module according to various embodiments as described above. It may have a plurality of configuration registers 1060, 1070 that are special function registers of the microcontroller 1000 and may be memory mapped to the data memory 1030. The microcontroller 1000 may have a plurality of external pins that in a default setting operate as digital or analog I/O ports 1080. Some of these pins 1080 may be configurable to be assigned to the SPI module as shown in FIG. 10. For example, one pin CLK may be assigned to transmit or receive a clock signal, one pin SDI may be used as a serial data input pin, one pin SDO may be used as a serial data output pin, and one pin #SS may be used as slave select or frame synchronization pin. When activating the SPI peripheral 1050, a minimum of pins CLK and SDI or SDO may be used. In addition, a CS pin may be used, in particular if more than one slave unit communicates over the same bus. Generally, a plurality of such pins may be required for a master depending on the application and therefore these pins are simply I/O port pins and will be manually set by software. However, some embodiments of an SPI interface module 1050 may automatically control one or more such pins.

1. A synchronous serial peripheral device comprising: a transmission unit coupled with a data output line and a clock unit coupled with a clock line, wherein the serial peripheral device transmits a minimum of a single transmission, wherein in a first operating mode the transmission unit and the clock unit are configurable to perform a data transmission with a data length that can be defined to be between one (1) and eight (8) bit.

2. The synchronous serial peripheral device according to claim 1, further comprising a FIFO memory coupled with the transmission unit, wherein the peripheral device is further configurable to operate in a second operating mode in which a transmission consists of a transmission frame comprising a plurality of 8-bit words from the FIFO memory followed by a single data transmission word from the FIFO memory having a data length that can be defined to be less than eight (8) bit.

3. The synchronous serial peripheral device according to claim 2, wherein a single bit in a configuration register determines whether the first or second operating mode is active.

4. The synchronous serial peripheral device according to claim 1, further comprising a reception unit coupled with a data input line, wherein the serial peripheral device is configured to receive a variable bit length single serial transmission, wherein in the first operating mode the reception unit is configurable to receive a data transmission with the defined data length.

5. The synchronous serial peripheral device according to claim 1, wherein in the first operating mode a plurality bits in a configuration register determine the data length.

6. The synchronous serial peripheral device according to claim 2, wherein in the second operating mode a first number of special function register bits determine a number of consecutive 8-bit words and a second number of special function register bits determine the number of bits of the single data transmission word after the consecutive 8-bit words have been transmitted.

7. The synchronous serial peripheral device according to claim 1, wherein in the first operating mode a first number of special function register bits determine the data length and in the second operating mode a second number of special function register bits determine a number of consecutive 8-bit words and the first number of special function register bits determine the number of bits of the single data transmission word.

8. The synchronous serial peripheral device according to claim 7, wherein a single special function register comprises the first and second number of special function register bits.

9. The synchronous serial peripheral device according to claim 1, further comprising a finite state machine controlling a clock signal transmitted on the clock line.

10. The synchronous serial peripheral device according to claim 9, further comprising a byte counter and a bit counter controlling the finite state machine.

11. The synchronous serial peripheral device according to claim 9, wherein the bit counter controls the transmission unit.

12. The synchronous serial peripheral device according to claim 1, wherein a PWM/Manchester encoding for each bit of data is emulated by adjusting the baud rate, the number of bits, and the data to achieve the required modulated pattern.

13. The synchronous serial peripheral device according to claim 1, further comprising a slave control input.

14. The synchronous serial peripheral device according to claim 1, further comprising separate data input and data output lines.

15. A microcontroller comprising a synchronous serial peripheral device according to claim 1.

16. A method of operating a synchronous serial peripheral device, comprising the steps of: configuring the synchronous serial peripheral device to operate in a first transmission mode;
setting a transmission bit width to length less than 8 bits;
moving data into a transfer buffer;
wherein in master mode upon receiving said data the synchronous serial peripheral device transmits data on a data line and an associated clock signal on a clock line, wherein a number of bits less than 8 bits is transmitted on the data line and a number of less than 8 clock pulses is transmitted on the clock line.

17. The method according to claim 16, wherein in slave mode, the synchronous peripheral device transmits data on a data line upon receiving clock signal from the master on a clock line.

18. The method according to claim 16, further comprising the steps of:
configuring the synchronous serial peripheral device to operate in a second transmission mode;
setting a number of 8-bit words and a bit width to length less than 8 bits;
moving data into a transmission FIFO memory;
wherein upon receiving a trigger, the synchronous serial peripheral device transmits a plurality of 8-bit words from the transmission FIFO memory followed by a single data transmission word having a data length that can be defined to be less than eight (8) bit.

19. The method according to claim 18, wherein a single bit in a configuration register determines whether the first or second operating mode is active.

20. The method according to claim 18, wherein setting a bit in a control register generates the trigger.

21. The method according to claim 18, further comprising:
when in the first operating mode, receiving a data word having said transmission bit width, and
when in the second operating mode, receiving said number of 8-bit words and a final word having a length of less than eight bits, wherein each received word is transferred into a reception FIFO memory.

22. The method according to claim 18, wherein in the first operating mode a plurality bits in a configuration register determine the data length.

23. The method according to claim 21, wherein in the first operating mode a first number of special function register bits determine the data length and in the second operating mode a second number of special function register bits determine a number of consecutive 8-bit words and the first number of special function register bits determine the number of bits of the single data transmission word.

24. The method according to claim 16, wherein a PWM/Manchester encoding for each bit of data is emulated by adjusting the baud rate, the number of bits, and the data to achieve the required modulated pattern.
